(19) United States
(12) Patent Application Publication
(10) Pub. No.: US 2025/0060165 A1
(43) Pub. Date: Feb. 20, 2025

(54) MAGNETICALLY ENHANCED BOILER

(71) Applicant: Blue Origin, LLC, Kent, WA (US)

(72) Inventors: Daniel A. Asturias, Seattle, WA (US); Michael Friedman, Belton, TX (US); Gary D. Grayson, Maple Valley, WA (US)

(21) Appl. No.: 18/449,071

(22) Filed: Aug. 14, 2023

(51) Int. Cl. F28D 1/02; F17C 7/04; F28F 27/02

(52) U.S. Cl. CPC F28D 1/0213; F17C 7/04; F28F 27/02; F17C 2201/0109; F17C 2221/011; F17C 2223/0161; F17C 2227/0302; F17C 2270/0197

(57) ABSTRACT

Techniques and systems involve a magnetically enhanced cryogenic boiler that produces, without requiring pumps, high pressure gaseous oxygen from liquid oxygen for use in a spacecraft or other applications. The boiler heats, using a heat exchanger element, a closed container of liquid oxygen to boil the liquid oxygen at constant volume and increasing the pressure in the container. When a desired target pressure is reached, the boiler may release and transfer the high pressure fluid into a gaseous oxygen accumulator for storage. Magnets may be used to draw low pressure liquid oxygen into the boiler and to keep the liquid oxygen on or near one or more heat exchanger elements in the boiler, by exploiting paramagnetism of oxygen. The magnets produce a magnetic field that maintains relatively strong thermal contact between the heat exchanger elements and the liquid oxygen, even in the absence of gravity.

### BACKGROUND

Liquid hydrogen and liquid oxygen are commonly used as propellants for space vehicles. In addition to its use as a propellant, liquid oxygen may be utilized in additional roles, such as in maintaining breathable atmospheric conditions within space vehicles and power generation from fuel cells. To be a liquid, hydrogen and oxygen must be cooled to a cryogenic state.

In the absence of gravity, there is no substantial force acting on liquids, which would otherwise rest at the bottom of a tank. Indeed, a tank “bottom” is generally defined by the direction of gravity. Without gravity, surface tension becomes a dominant force and causes liquids to adhere to and wrap around tank walls instead of collecting at the tank “bottom.” This behavior may make it difficult to transfer liquid propellant in or out of a tank. For example, a process of filling a tank may result in inflowing liquid propellant tending to cling to the sides of the tank. This behavior also makes it difficult to determine how much liquid propellant is in a tank. Pressurizing the tank assists in filling the tank and may be necessary for operating propulsion and reaction control systems of a space vehicle. Similarly, pressurization can be utilized to transfer liquid propellants between tanks in refilling operations. Such pressurization may occur in a number of ways, such as by processes of heating and/or pumps. Unfortunately, space-rated pumps are generally expensive, custom designed, and may be associated with high development and operational risks. Furthermore, such pumps generally require relatively large amounts of electric or pneumatic power to operate.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic view of a boiler system, according to some embodiments.

FIG. 2 is a close-up schematic view of a boiler tank, according to some embodiments.

FIG. 3 is a graph of paramagnetism as a function of temperature for gas and liquid phases of oxygen, as applied in some embodiments.

FIG. 4 is a graph of rate of heat transfer as a function of temperature, as applied in some embodiments.

FIG. 5 is a flow diagram of a process for heating a two-phase fluid, according to some embodiments.

FIG. 6 is a flow diagram of a process for operating a boiler, according to some embodiments.

### DETAILED DESCRIPTION

This disclosure describes a number of techniques and systems, including a magnetically enhanced cryogenic boiler that produces, without requiring pumps, high pressure gaseous oxygen from liquid oxygen for use in a spacecraft or other applications. Gases of other elements (or compounds) besides oxygen may also be produced from their liquid counterpart and claimed subject matter is not limited to embodiments directed to oxygen, which is merely one example of many possible gases/liquids having a relatively high magnetic susceptibility. To eliminate a need for pumps to produce requisite pressures, the magnetically enhanced cryogenic boiler, hereinafter “boiler”, heats, using a heat exchanger element, a closed container of liquid oxygen to boil the liquid oxygen at constant volume, thus increasing the pressure in the container. When a desired target pressure is reached, the boiler may release and transfer the high pressure fluid, which may be in a gas phase, into an accumulator for storing gaseous oxygen. Such transfer may occur directly or via a subsequent heat exchanger process. Magnets (e.g., permanent magnets or electromagnets) may be used to draw low pressure liquid oxygen into the boiler and to keep the liquid oxygen on or near one or more heat exchanger elements in the boiler by exploiting paramagnetism of oxygen. The magnets produce a magnetic field that maintains relatively strong thermal contact between the heat exchanger elements and the liquid oxygen. Thermal contact, which would otherwise be difficult to maintain without such applied magnetism in the absence of substantial gravity, is needed to effectively boil the liquid oxygen.

A cryogenic liquid-gas conversion system for oxygen may be a subsystem of a supply system for the oxygen as a propellant. Or the oxygen, in liquid or gas form, may be utilized in additional roles, such as in maintaining breathable atmospheric conditions within a space vehicle and power generation from fuel cells, among other things. A cryogenic liquid-gas conversion system generally needs pumps to pressurize liquid oxygen to a target pressure before it can be heated to a desired gas temperature. Spacecraft-rated pumps are relatively expensive and are likely associated with high developmental and operational risks. Also, such pumps generally require relatively large amounts of electric or pneumatic power to operate. Embodiments of boiler systems described herein, however, may eliminate the need for pumps. Elimination of moving parts, such as those of pumps, may increase subsystem lifetimes, and this provides a major benefit for spacecraft operations.

Liquid-gas conversion systems may have a target pressure well above the critical pressure of oxygen, above which the liquid and gas phases, herein collectively referred to as a fluid, are no longer distinct. Liquid-gas conversion systems may rely on pool boiling, which requires a body force like gravity that preferentially acts on the liquid to keep it in contact with a heating element (e.g., at the bottom of a tank). Gravity also acts to displace vapor bubbles created at the surface of the heating element (e.g., nucleate boiling). However, above the critical pressure, and/or an absence of substantial gravity, there may not be clear/distinct separation of the gas and liquid phases, and therefore no pool boiling, and so further heating of the fluid is principally driven by natural convection. In relatively low gravity (e.g., microgravity), however, the absence of substantial gravity suppresses the formation of convection currents such that the primary mode of heat transfer becomes conduction through the fluid, which has a substantially lower heat transfer coefficient, resulting in unreasonably long heating times (e.g., low rate of heat transfer) to reach the target pressure and temperature.

Placing one or more magnets near or on a heating element may preferentially attract liquid over a gas phase (e.g., vapor). The displacement of vapor by liquid may cause the vapor to coalesce into bubbles and be expelled. This process is analogous to how gravity acts on liquid and gas phases during ordinary nucleate boiling, for example. The relatively strong paramagnetic attraction of liquid oxygen by a magnet may beneficially interfere with vapor adhesion to the heating element during nucleate boiling and may induce early coalescence into a bubble and subsequent expulsion from the heating element surface, acting in a similar fashion to gravity's effect on pool boiling. Thus, the nucleate boiling region may be extended to higher temperatures and the critical heat flux may be increased, delaying the onset of transition boiling and accentuating the heat transfer performance of the heating element.

The strength of the paramagnetic effect of oxygen is temperature dependent and phase dependent. For example, for a given temperature, the paramagnetic effect is greater for liquid oxygen than for gaseous oxygen. These dependencies may allow magnets to set up local convection currents near a heat exchanger element, such as that of a boiler, as their magnetic field preferentially attracts, among the fluid, colder liquid oxygen over both warmer liquid oxygen and gaseous oxygen (which has poor heat conductivity). These convection currents, and the preferential attraction of liquid over gas, enhance heat transfer from the heat exchange element and induce greater bulk mixing of the fluid. Thus, pool boiling can be achieved in a low gravity environment, such as microgravity, without the severe degradation of heat flux that would otherwise be expected.

Advantages of a boiler as a gas generation system include allowing for elimination of pumps and providing flexibility and tunability of target pressures and temperatures of the produced gas. Advantages of a magnetically enhanced boiler over other boilers performing in low gravity are faster and more controlled liquid tank filling processes, enhanced retainment of thermal contact between liquid and heating elements during boiling, and the resulting enhancement of the heat transfer coefficient leading to a reduction in boiler mass and cycle time, thus increasing potential gas production. Though embodiments described herein are often directed to low gravity environments, the boiler may also function in gravity that is as great or greater than that of Earth. Claimed subject matter is not limited in this respect.

In some embodiments, a heat exchanger, which may be incorporated in a boiler, for a two-phase (e.g., liquid and gas) fluid, may include a heat exchanger element configured to be submersed in the two-phase fluid and a magnet configured to apply a magnetic field to the two-phase fluid. The strength of the magnetic field in a region nearest the heat exchanger element may be substantially stronger than regions further from the heat exchanger element. The two-phase fluid is paramagnetic (possible diamagnetic if poles of magnets herein described are reversed). The heat exchanger may further include a tank that encloses the heat exchanger element and that is configured to contain the two-phase fluid. The magnet may be a superconducting electromagnet and may be located within the tank where the superconducting magnet can be cooled by the two-phase fluid. In some implementations, the heat exchanger element comprises a material that does not interfere or redirect flux lines of the magnetic field. For example, steel or other ferromagnetic materials may redirect, and thus reduce a strength of, magnetic flux in the region of the heat exchanger element.

In some embodiments, a method of heating a two-phase fluid, may include submersing a heat exchanger element in the two-phase fluid and applying a magnetic field to the two-phase fluid. In particular, the strength of the magnetic field in a region nearest the heat exchanger element may be substantially stronger than regions further from the heat exchanger element. The two-phase fluid is paramagnetic. The method may further include enclosing the heat exchanger element in a tank configured to contain the two-phase fluid. Applying the magnetic field to the two-phase fluid may be performed using a superconducting electromagnet placed within or outside the tank. The two-phase fluid may comprise oxygen in a liquid state and a gas state. An attractive force applied by the magnetic field to the oxygen in the liquid state may be greater than an attractive force applied by the magnetic field to the oxygen in the gas state. The method may be performed in a low gravity environment. In some implementations, the combination of the heat exchanger element, the magnetic field, and the tank may be operated as a boiler that receives liquid oxygen from a storage tank. Within the boiler the heat exchanger element may operate in the magnetic field to increase pressure of the liquid oxygen.

In some embodiments, a method of operating a boiler, may include at least partially filling the boiler with liquid oxygen and applying i) heat energy via a heat exchanger element to the liquid oxygen and ii) a magnetic field to the liquid oxygen in a region surrounding the heat exchanger element. The heat exchanger element may provide the heat energy by transferring the heat energy to the liquid oxygen from a fluid flowing in the heat exchanger element. In other implementations, the heat exchanger element may be an electric heating coil that heats by intrinsic resistance of the coil material. Applying heat energy and the magnetic field may lead to increasing temperature and pressure of the liquid oxygen. The strength of the magnetic field in the region surrounding the heat exchanger element may be substantially stronger than regions further from the heat exchanger element. The method further includes releasing oxygen gas, which is formed from the liquid oxygen, from the boiler when the pressure reaches a target pressure. The method may further include stopping the release of the oxygen gas from the boiler when the pressure lowers to a low-threshold pressure, further applying heat energy and magnetic field to the liquid oxygen and, when the pressure reaches the target pressure, further releasing the oxygen gas from the boiler. Such a cycle of releasing oxygen gas and subsequently re-raising the pressure by repeated heating may be repeated multiple times until, for example, the supply of liquid oxygen runs low or an operator desires no more oxygen gas. In some implementations, the gas pressure may reach the target pressure subsequent to the liquid oxygen reaching the critical point of oxygen.

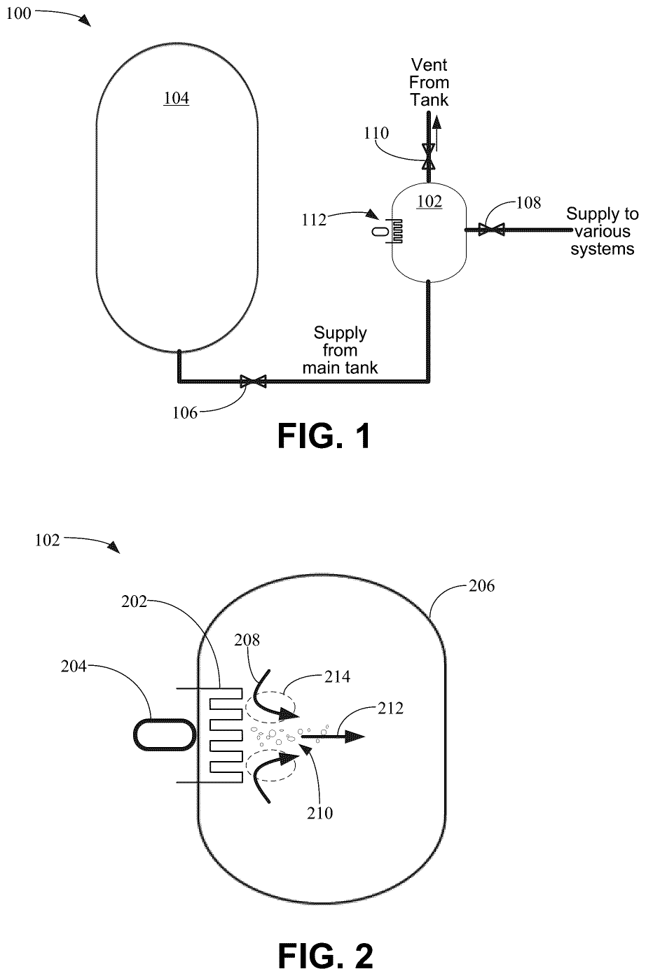

FIG. 1 is a schematic view of a boiler system 100 for cryogenic oxygen, according to some embodiments. System 100 includes a boiler 102, a supply tank 104 to provide oxygen to the boiler, a valve 106 to control flow of oxygen between the supply tank and the boiler, a valve 108 to control flow of high pressure oxygen gas out of the boiler in order to provide the oxygen gas to a storage container, a heat exchanger, or any of various oxygen-using systems, and a valve 110 to control venting of oxygen to outside system 100. Though they are not illustrated, numerous other connections may exist. boiler 102 includes a heat exchanger sub-system 112 that is configured to provide a magnetic field to oxygen in the boiler, as described below.

In some embodiments, boiler 102 may be operated by at least partially filling the boiler with liquid oxygen and using heat exchanger sub-system 112 to apply heat energy and a magnetic field to the liquid oxygen in a region of the boiler tank nearest the heat exchanger sub-system. Applying heat energy and the magnetic field may lead to increasing temperature and pressure of the liquid oxygen. High pressure oxygen gas, which is formed from the liquid oxygen in the boiler and originally from supply tank 104, may be released from the boiler when the pressure reaches a target pressure. Valve 108 may be opened to allow the flow of the high pressure oxygen gas to supply a storage container or one or more various downstream systems, for example. In some embodiments, the high pressure oxygen may travel to a heat exchange sub-system for further adjustments to pressure and temperature of the oxygen gas. By releasing the high pressure oxygen gas from the boiler, pressure in the boiler tank may lower and the remaining oxygen may cool. When the pressure in the boiler tank lowers to a low-threshold pressure, valve 108 may close to halt the release of the oxygen gas. Prior steps may be repeated as part of a cycle that may occur multiple times. For example, heat energy and the magnetic field may again be applied to the oxygen remaining in the boiler tank, leading to increasing temperature and pressure of the liquid oxygen. High pressure oxygen gas is again formed from the liquid oxygen in the boiler and may be released from the boiler when the pressure again reaches the target pressure. Again, by releasing the high pressure oxygen gas from the boiler, pressure in the boiler tank may lower and the remaining oxygen may cool. This cycle may repeat until various oxygen-using systems no longer need oxygen gas, for example.

In some implementations, the magnetic field may help to retain the liquid oxygen in the boiler when valves 108 and/or 110 are opened. For example, boiler 102 may not need to wait until all of the liquid is converted to gas to avoid some liquid flowing downstream and possibly boiling and over-pressurizing downstream lines, leading to a pressure that is less predictable or less controllable. In contrast, a conventional boiler may have to boil the entire volume of liquid or risk wasting some of the liquid.

FIG. 2 is a close-up schematic view of boiler 102, according to some embodiments. boiler 102 includes a heat exchanger system comprising a heat exchanger element 202 and a magnet 204, which are collectively identified as heat exchanger sub-system 112 in FIG. 1. Though one magnet is schematically illustrated, magnet 204 may comprise two or more magnets, which may be permanent magnets or electromagnets. In some implementations, heat exchanger element 202 may be a coiled tube, for example, that carries flowing fluid that is substantially warmer than fluid inside tank 206 of the boiler. In other implementations, heat exchanger element 202 may be a resistive heating element that carries electrical current. Heat exchanger element 202 may comprise one or more individual elements in various sizes or configurations. Heat exchanger element(s) 202 need not be located in only one part of tank 206.

Magnet 204 may be a permanent magnet or an electromagnet. Magnet 204 may be located outside or inside tank 206. In some implementations, magnet 204 may be an electromagnet comprising one or more superconductive coils. In such implementations, magnet 204 may be inside tank 206 so that cryogenic oxygen may cool the superconductive coils.

Heat exchanger element 202 may be configured and located to be submersed in a two-phase fluid contained by tank 206. In embodiments described herein, the two-phase fluid is cryogenic oxygen in liquid and gas phases. Magnet 204 may be configured to apply a magnetic field to the two-phase fluid in a region relatively near heat exchanger element 202. For example, the strength of the magnetic field in a region nearest the heat exchanger element is substantially stronger than regions further from the heat exchanger element. Such a region nearest the heat exchanger element may be considered to be surrounding the heat exchanger element and extending a dozen or so centimeters from the heat exchanger element, though claimed subject matter is not so limited. This region may include a magnetic field that is strong enough to affect motions of two-phase oxygen. In contrast, other parts of tank 206 may include two-phase oxygen that is not subjected to a magnetic field strong enough to substantially affect its motion.

As mentioned above, the strength of the paramagnetic effect of oxygen is temperature dependent and phase dependent. Thus, for a given temperature, the paramagnetic effect is greater for liquid oxygen than for gaseous oxygen. These dependencies may allow a magnetic field to create local convection currents 208 near heat exchanger element 202, because the magnetic field preferentially attracts, among the fluid, colder liquid oxygen over both warmer liquid oxygen and gaseous oxygen. The displacement of gaseous oxygen by liquid oxygen may cause the gaseous oxygen to coalesce into bubbles and be expelled. Convection currents 208, and the preferential attraction of liquid over gas, enhance heat transfer from heat exchange element 202 and induce greater bulk mixing of the fluid in tank 206.

The relatively strong paramagnetic attraction of liquid oxygen by the magnetic field may also beneficially interfere with oxygen vapor adhesion to heat exchanger element 202 during nucleate boiling. The magnetic field may induce early coalescence of the oxygen into a bubble, and expulsion from the heating element surface. Such bubbles 210 illustrate a general direction 212 of flow of gaseous oxygen in tank 206 away from the heat exchanger element. Convection currents 208 may arise from the flow of bubbles 210 away from heat exchanger element 202. The magnetic field tends to pull in liquid, resulting in expulsion of gas bubbles, thus creating a current. A substantially bubble-free region may be created by the continuous influx of liquid oxygen flowing toward the magnet, and not necessarily the magnetic field pushing the bubbles away from the magnet (e.g., the liquid tending to reach the magnet pushes bubbles out of the way). As mentioned above, these currents may enhance heat transfer from the heat exchanger element to the oxygen. In regions 214, bubbles may be almost entirely excluded as a result of vapor created from boiling at or near the heat exchanger element being ejected by the magnetic field from these regions as the stream of bubbles illustrated in the figure. In some implementations, the direction of a general path followed by the bubbles may be changed by changing angles of magnetic flux, such as by changing angles of magnet(s) 204. The fluid is drawn generally toward the highest gradient that occurs from the edges of the magnet(s).

The effects described above may extend the nucleate boiling region to higher temperatures and raise the critical heat flux, delaying the onset of transition boiling and accentuating the heat transfer performance of the heating element.

In other embodiments, boiler 102 may be a “self-contained” system that need not include a supply tank, such as 104. In still other embodiments, a system comprises a tank, such as 104, that includes a heat exchanger element, such as 202, and a magnet, such as 204. A system of such embodiments need not include an external (e.g., separate) tank acting specifically as a boiler.

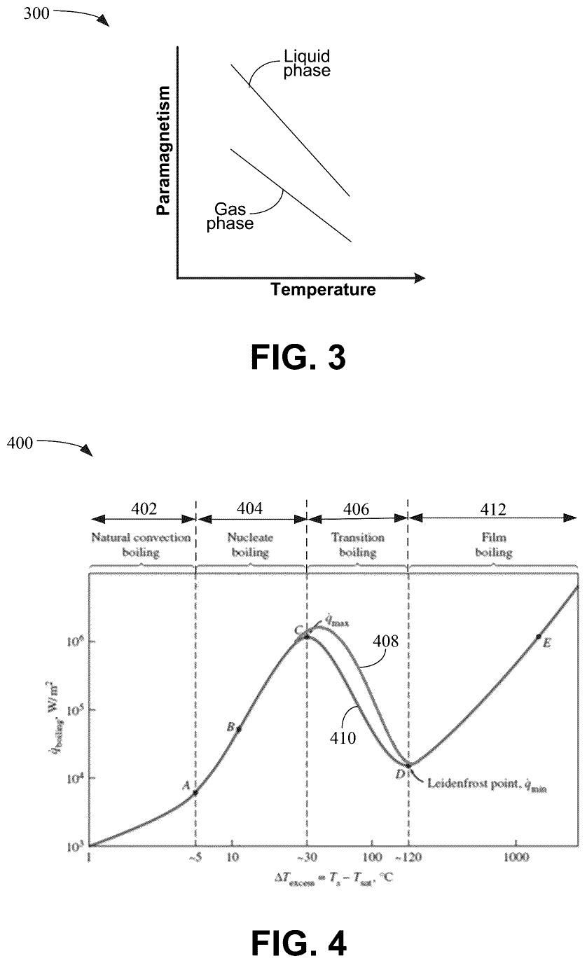

FIG. 3 is a graph 300 of paramagnetism as a function of temperature for gas and liquid phases of oxygen, as applied in some embodiments. Graph 300 is not necessarily to scale, and the temperature range illustrated is in a low-temperature, cryogenic regime where oxygen can be in a liquid state and possess a natural paramagnetic susceptibility. Paramagnetic behavior of oxygen, when placed in various phases by combinations of temperature and pressure, may become relatively complicated. For example, paramagnetism of gaseous oxygen, which may be in a supercritical phase when mixed with liquid oxygen at boiling temperature in a high pressure vessel, may not follow the linear plot illustrated in FIG. 3. Claimed subject matter is not limited in this respect. Regardless of such details, the figure reliably sets forth the fact that paramagnetism is greater for oxygen in a liquid phase than for a gas phase at a given temperature.

Generally, magnetism occurs due to the atomic or molecular structure of a material and can be classified as ferromagnetic, diamagnetic, or paramagnetic. Ferromagnetic solids have permanently aligned poles and generate their own magnetic fields. Liquids, however, cannot maintain the alignment without a magnetic field and are either paramagnetic, in which the poles align with the applied magnetic field, or diamagnetic, in which the poles align opposite the applied magnetic field. The bulk effect of each type is that paramagnetic materials are attracted to a magnetic field (toward an increasing gradient) and diamagnetic materials are repelled by a magnetic field (away from an increasing gradient).

In all phases, unpaired electrons in an oxygen (O₂) molecule lead to a bulk paramagnetic effect. At room temperature, however, the thermal energy within the molecules may dominate the magnetic alignment with an applied field. Thus, relatively warm oxygen does not have an appreciable susceptibility. As temperature decreases and thermal energy is reduced, the molecules are increasingly able to align and susceptibility increases. This phenomenon is known as Curie's Law, where, essentially, paramagnetic susceptibility increases as temperature decreases. Once oxygen condenses (e.g., 90 K, 1 atm), the volumetric susceptibility, x, significantly increases with the density of the fluid. The relationship between volumetric susceptibility, mass susceptibility, χₘₐₛₛ, and molar susceptibility, χₘₒₗₐᵣ, is defined through density, ρ, and molecular weight, Wₘₒₗ, as

$$χ = ( 1 / ρ ) {χ}_{mass} / {W}_{mol}$$

At low temperatures, the volumetric susceptibility saturates to a constant. The magnitude of a resulting magnetization M is thus linearly dependent on an applied magnetic field H:

M=χH

Graph 300 illustrates that paramagnetism, and thus a resulting strength of attraction in a magnetic field, is greater for oxygen in a liquid phase than for a gas phase at a given temperature. Thus, as described above for a magnetic field applied in a region surrounding a heat exchanger element, a magnetic attraction to this region is greater for oxygen in a liquid phase than for oxygen in a gas phase. This difference in magnetic attraction leads to liquid oxygen displacing gaseous oxygen near the heat exchanger element, resulting in relatively efficient (e.g., greater rate of) heat transfer from the heat exchanger element to the oxygen.

FIG. 4 is a graph 400 of rate of heat transfer as a function of temperature, according to some embodiments. The rate of heat transfer is plotted across various boiling regimes. Such heat transfer may be performed by a heat exchanger element, such as 202. In natural convection boiling, regime 402, vapor may be observed over the liquid surface. As the superheat temperature increases, bubble inception will eventually occur. Below point A, fluid motion is determined principally by natural convection currents. For example, fluid motion may be caused by buoyancy from the difference in fluid density occurring due to temperature gradients.

Nucleate boiling, regime 404, is a type of boiling that takes place when the surface temperature is hotter than the saturated fluid temperature by a certain amount, but where the heat flux is below the critical heat flux. Transition boiling, regime 406, may be defined as unstable boiling, which occurs at surface temperatures between the maximum attainable in nucleate and the minimum attainable in film boiling. In this region, the effect of applying a magnetic field in the region of the heat exchanger element can be observed by a difference of rate of heat transfer illustrated by a portion 408 of the plot compared to a portion 410 of the plot. Portion 408 represents the rate of heat transfer as a function of temperature with an applied magnetic field. Portion 410 represents the rate of heat transfer as a function of temperature without such an applied magnetic field. The difference between portions 408 and 410 illustrate the improvement of heat transfer efficiency by applying a magnetic field to a region surrounding a heat exchanger element.

If a surface heating the liquid is significantly hotter than the liquid, then film boiling, regime 412, may occur, wherein a thin layer of vapor, which has low thermal conductivity, insulates the surface. This condition occurs beyond the Leidenfrost point.

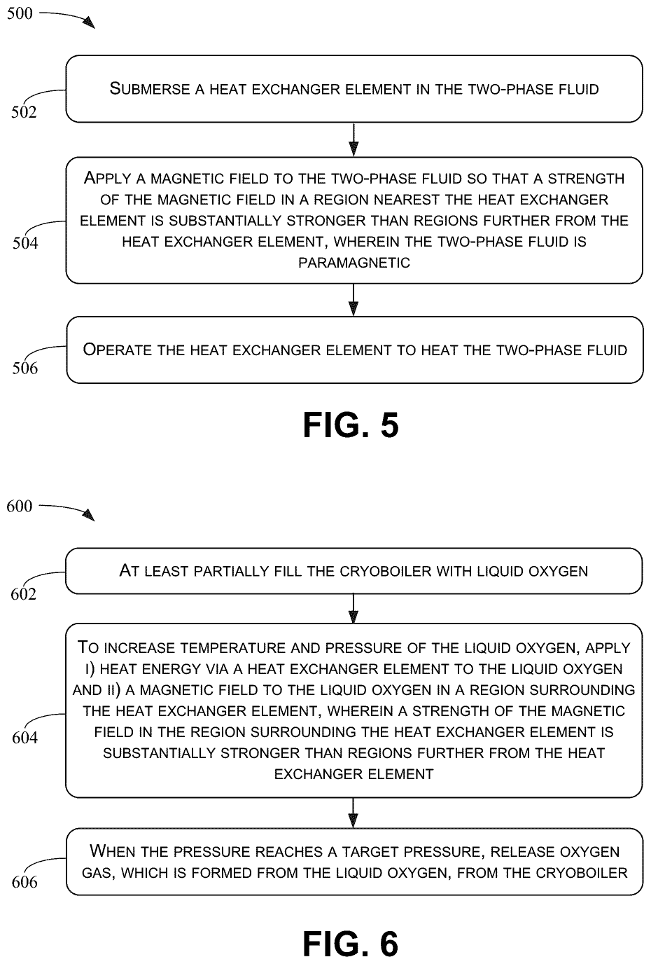

FIG. 5 is a flow diagram of a process 500 for heating a two-phase fluid, according to some embodiments. Process 500 may be implemented by an operator, which may be a person, a computer processor, or a combination of both, for example.

At 502, the operator may submerse a heat exchanger element in the two-phase fluid, which may be oxygen in liquid and gas phases, and may be in a container that resists pressure. The two-phase fluid may be paramagnetic. At 504, the operator may apply a magnetic field to the two-phase fluid so that a strength of the magnetic field in a region nearest the heat exchanger element is substantially stronger than regions further from the heat exchanger element. At 506, the operator may operate the heat exchanger element to heat the two-phase fluid. The purpose for such heating may be for producing high pressure oxygen gas, among other things.

FIG. 6 is a flow diagram of a process 600 for operating a boiler, according to some embodiments. At 602, the operator may at least partially fill the boiler with liquid oxygen, which may be sourced from a supply tank, such as 104. At 604, the operator may, in order to increase temperature and pressure of the liquid oxygen, apply i) heat energy via a heat exchanger element to the liquid oxygen and ii) a magnetic field to the liquid oxygen in a region surrounding the heat exchanger element. A strength of the magnetic field in the region surrounding the heat exchanger element may be substantially stronger than regions further from the heat exchanger element. At 606, the operator may, when the pressure reaches a target pressure, release oxygen gas, which is formed from the liquid oxygen, from the boiler.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A heat exchanger for a two-phase fluid, the heat exchanger comprising:
a heat exchanger element configured to be submersed in the two-phase fluid; and
a magnet configured to apply a magnetic field to the two-phase fluid, wherein a strength of the magnetic field in a region nearest the heat exchanger element is substantially stronger than regions further from the heat exchanger element, and wherein the two-phase fluid is paramagnetic.

2. The heat exchanger of claim 1, further comprising a tank enclosing the heat exchanger element and configured to contain the two-phase fluid.

3. The heat exchanger of claim 2, wherein the magnet is a superconducting electromagnet, and wherein the superconducting electromagnet is located within the tank.

4. The heat exchanger of claim 1, wherein the two-phase fluid comprises oxygen in a liquid state and a gas state.

5. The heat exchanger of claim 4, wherein an attractive force between the magnet and the oxygen in the liquid state is greater than an attractive force between the magnet and the oxygen in the gas state.

6. The heat exchanger of claim 1, wherein the heat exchanger element comprises a material that does not redirect flux lines of the magnetic field.

7. A method of heating a two-phase fluid, the method comprising:
submersing a heat exchanger element in the two-phase fluid;
applying a magnetic field to the two-phase fluid so that a strength of the magnetic field in a region nearest the heat exchanger element is substantially stronger than regions further from the heat exchanger element, wherein the two-phase fluid is paramagnetic; and
operating the heat exchanger element to heat the two-phase fluid.

8. The method of claim 7, further comprising enclosing the heat exchanger element in a tank configured to contain the two-phase fluid.

9. The method of claim 8, wherein applying the magnetic field to the two-phase fluid is performed using a superconducting electromagnet placed within the tank.

10. The method of claim 7, wherein the two-phase fluid comprises oxygen in a liquid state and a gas state.

11. The method of claim 10, wherein an attractive force applied by the magnetic field to the oxygen in the liquid state is greater than an attractive force applied by the magnetic field to the oxygen in the gas state.

12. The method of claim 7, wherein operating the heat exchanger element is performed in a low gravity environment.

13. The method of claim 8, wherein a combination of the heat exchanger element, the magnetic field, and the tank is a boiler that receives liquid oxygen from a storage tank, the method further comprising:
operating the heat exchanger element in the magnetic field to increase pressure of the liquid oxygen.

14. A method of operating a boiler, the method comprising:
at least partially filling the boiler with a two-phase fluid;
to increase temperature and pressure of the two-phase fluid, applying i) heat energy via a heat exchanger element to the two-phase fluid and ii) a magnetic field to the two-phase fluid in a region surrounding the heat exchanger element, wherein a strength of the magnetic field in the region surrounding the heat exchanger element is substantially stronger than regions further from the heat exchanger element; and
when the pressure reaches a target pressure, releasing gas, which is formed from the two-phase fluid, from the boiler.

15. The method of claim 14, further comprising:
stopping the release of the gas from the boiler when the pressure lowers to a low-threshold pressure;
further applying the heat energy and the magnetic field to the two-phase fluid; and
when the pressure reaches the target pressure, further releasing the gas from the boiler.

16. The method of claim 14, wherein applying the magnetic field to the two-phase fluid is performed using a superconducting electromagnet placed within the boiler.

17. The method of claim 14, wherein an attractive force applied by the magnetic field to the two-phase fluid is greater than an attractive force applied by the magnetic field to the two-phase fluid in the gas state.

18. The method of claim 14, further comprising operating the boiler in a low gravity environment.

19. The method of claim 14, wherein the pressure reaches the target pressure subsequent to the two-phase fluid reaching the critical point of two-phase fluid.

20. The method of claim 14, wherein the heat exchanger element provides the heat energy by transferring the heat energy to the two-phase fluid from a fluid flowing in the heat exchanger element.
